(19) United States
(12) Patent Application Publication
(10) Pub. No.: US 2007/0151436 A1
(43) Pub. Date: Jul. 5, 2007

(54) Saw blade for a handheld working tool

(75) Inventors: Ove Donnerdal, Savedalen (SE); Fredrik Karlsson, Goteborg (SE)

Correspondence Address: PEARNE & GORDON LLP, 1801 EAST 9TH STREET, SUITE 1200, CLEVELAND, OH, 44114-3108, US

(73) Assignee: AKTIEBOLAGET ELECTROLUX, STOCKHOLM (SE)

(21) Appl. No.: 10/583,217

(22) PCT Filed: Dec. 29, 2004
(86) PCT No.: PCT/SE04/02057

§ 371 Date: Aug. 14, 2006

(30) Foreign Application Priority Data
Dec. 30, 2003 (SE) 0303561-5

(51) Int. Cl. B23D 57/00

(52) U.S. Cl. 83/835

(57) ABSTRACT

A saw blade (1) intended for a handheld working tool, and the saw blade comprises a blade body (2) having an outer periphery (3) with a number of teeth (4) arranged by fastening a separate part or through a local addition of a surface lining material. The teeth occupy less than 0,2 times of the periphery (3) of the saw blade and in that rotation-wise in front of at least a tooth (4) there is a notch (5) that runs towards the center of the saw blade and this notch has a narrow opening (6) at the periphery and preferably widens considerably inside the opening to a widened part (7) and the widened part has a width (b) that is greater than 1,3 times the width (a) of the opening. Rotation-wise in front of the narrow opening (6) the outer periphery (3) of the blade body (2) has a maximum radius essentially from a center (11) of the saw blade and this maximum radius is maintained during at least 55% in succession, and preferably during at least 70%, of a peripheral distance from the narrow opening to the start of the next tooth and the tooth (4) has an edge (8) at its outer foremost end, i.e. first in the direction of rotation and a front side (9) of the tooth (4) at the edge (8) forms a negative rake angle α from the edge and to the center (11) of the saw blade, and the angle α is greater than 0 degrees and preferably greater than 8 degrees but smaller than 30 degrees.

### TECHNICAL FIELD

The subject invention refers to a saw blade intended for a handheld working tool, and the saw blade comprises a blade body having an outer periphery with a number of teeth arranged by permanent fastening of a separate part or through a local addition of a surface lining material. More specifically, the teeth occupy less than 0.2 times of the periphery (3) of the saw blade and that rotation-wise in front of at least a tooth (4) there is a notch (5) that runs towards the center of the saw blade and this notch has a narrow opening (6) at the periphery and preferably widens considerably inside the opening to a widened part (7), and the widened part has a width (b) that is greater than 1.3 times the width (a) of the opening.

### BACKGROUND OF THE INVENTION

Today saw blades intended for use in handheld cut-off machines are only marketed for specially trained personnel like fire-fighters. These saw blades are also used for saving operations following earthquakes. In all these operations it is important to be quick in order to save lives. Therefore it is necessary to use powerful handheld tools. Of course there is a certain risk to use these machines, but this risk is offset by the special training of the personnel and the use of protective clothing. The saw blades used for these machines however produce fairly strong drive reactions to the operator. If the saw blade reaches a leg of the operator it could quickly produce a dangerous injury.

The assignee is not aware of any prior art from this specific technical field. From an official search in neighboring fields of prior art the following documents can be mentioned.

U.S. Pat. No. 4,515,055. describes a blade for a circular saw. It is provided with a ramp-like depth gauge portion on its periphery in front of each tooth. The ramp part covers only a minor portion of the peripheral distance of the blade body from one tooth to the other. In an accident situation such a ramp would provide a very short support against the operator's leg, which is of course soft and flexible as compared with normal materials as wood etc. Further, the big positive rake angle of the teeth will also contribute in providing a severe cut.

WO 01/70471 refers to a rotary saw blade for cutting a metal work piece. It has a very short depth gauge portion in front of each tooth and further it has a narrow opening in front of each tooth that is a of size more than 3 mm wide. Considering the blades small diameter of only 184 mm approximately this is in fact a big opening. Together with the minimum ramp this contributes in making this saw blade very aggressive in an accident situation.

FR 711837 describes a blade for a circular saw. However, it shows exchangeable teeth of a very special design, each having the shape of a circular bend. This creates a fragile tooth that further also has an extreme positive rake angle. This makes such a blade extremely unsuitable for cutting steel and concrete in rescue operations. Considering all this it is in doubt if it is a relevant piece of prior art.

### SUMMARY OF THE INVENTION

The purpose of the subject invention is to take away, or at least reduce, the above outlined disadvantages.

This purpose is achieved in a saw blade of the initially mentioned kind, wherein the saw blade is arranged as specified in the characterizing portion of claim 1. The fact that the maximum radius is maintained for at least 55% in succession creates a long support area in front of each tooth, and further has a negative rake angle, contributes in making a saw blade less aggressive in an accident situation. This is further improved by the narrow opening. All this also results in a very controlled feed of the saw blade when sawing. This makes the machine easier to hold and maneuver for the operator.

According to a preferred embodiment of the invention the front side of the tooth has an outer edge with a radial distance to the outer periphery of the blade body at the opening. This distance is 0.6-5 mm, and preferably is 0.6-2 mm.

### BRIEF DESCRIPTION OF THE DRAWINGS

The invention will be described in the following with reference to the accompanying drawing figures, which in the purpose of exemplifying are showing preferred embodiments of the invention.

FIG. 1 illustrates in a side-view a saw blade according to a first embodiment of the invention.

FIG. 2 illustrates an enlarged part of the saw blade of FIG. 1.

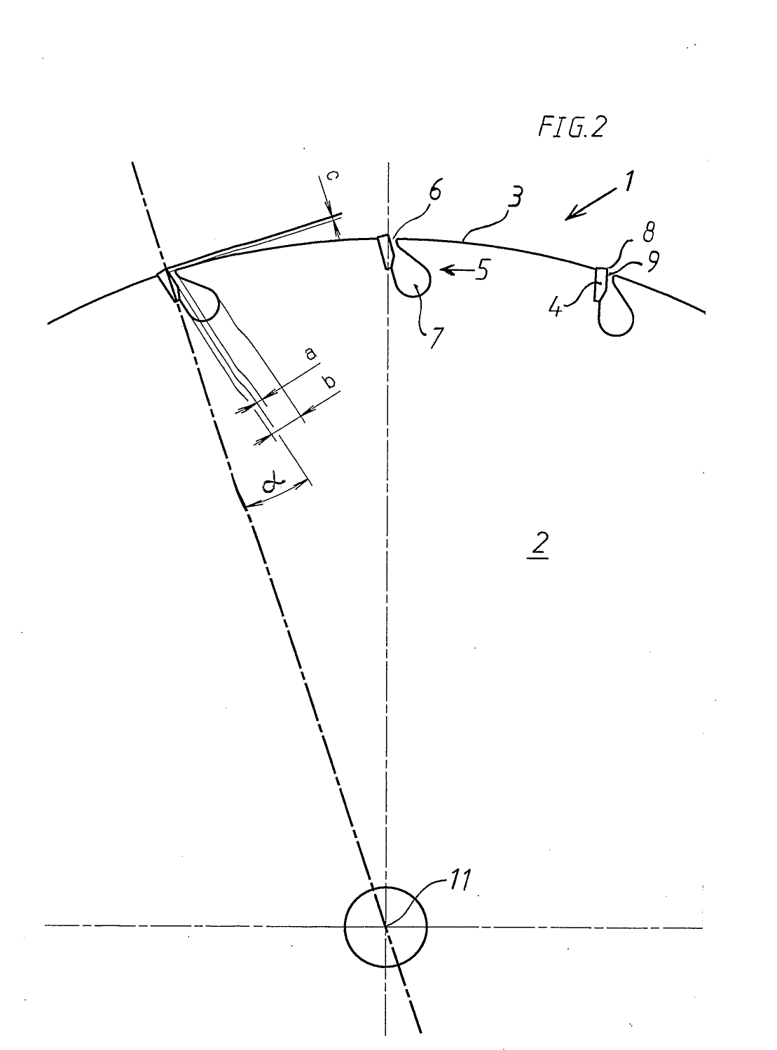

FIG. 3 illustrates in a side-view a second embodiment of the invention.

### DETAILED DESCRIPTION OF PREFERRED EMBODIMENTS

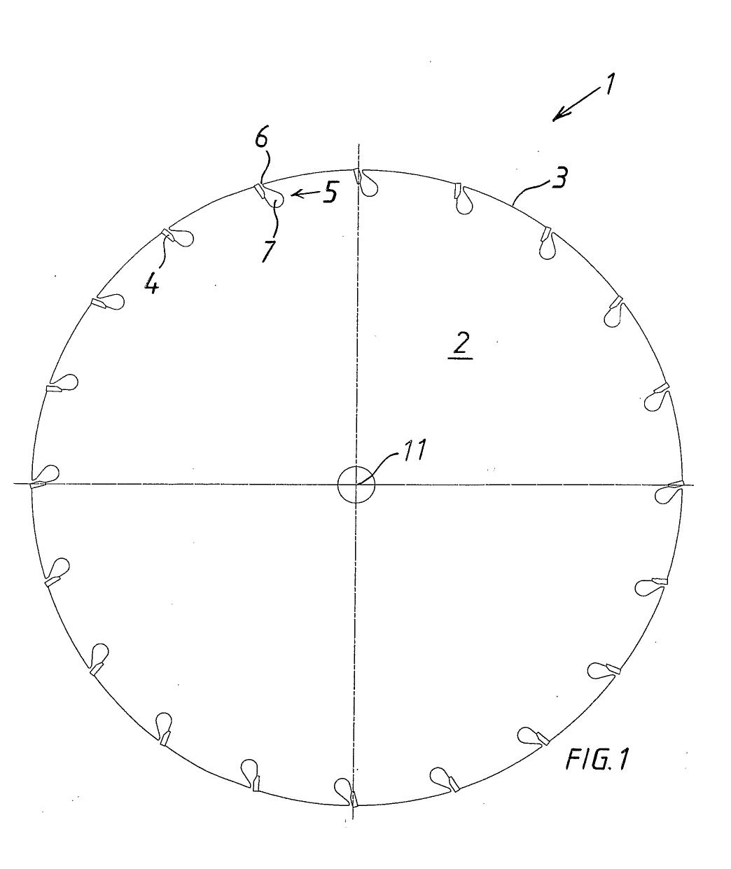

With reference to FIG. 1 a saw blade 1 according to a first embodiment of the invention is shown. The saw blade comprises a blade body 2 having an outer periphery 3 with a number of teeth 4 arranged by permanent fastening, i.e. the teeth are not interchangeable. Usually each tooth is made up by a separate part such as a carbide tip, which is a preferred solution. However, each tooth can also be arranged by a local addition of a surface lining material. One surface or a number of surfaces can be lined by this material that creates the especially hard tooth.

The teeth occupy only a minor part of the periphery 3 of the saw blade. This is distinctly different from a blade intended for grinding operations. Rotation-wise in front of at least one tooth 4 and preferably in front of every tooth there is a notch 5 that runs towards the center of the saw blade. This notch has a narrow opening 6 at the periphery. This narrow opening can be as small as 0.1 millimeter but can also be up to 7 millimeters wide. Preferably it is 0.5-4 millimeters wide, or even 0.5-2 millimeters wide. The narrow opening 6 widens considerably inside the opening to a widened part 7 and the widened part has a width b that is greater than 1,3 times the width a of the opening and preferably wider than two times its width, or preferably even wider than three times its width.

The tooth 4 has an edge 8 at its outer foremost end, i.e. first in the direction of rotation. The edge 8 has a radial distance c to the outer periphery of the blade body at the opening 6 which distance is 0.6-5 millimeters and preferably 0.6-2 millimeters.

The front side 9 of the tooth 4 at the edge 8 forms a negative rake angle α from the edge and to the center 11 of the saw blade, and the angle α is greater than 0 degrees but smaller than 30 degrees, preferably greater than 8 degrees but smaller than 20 degrees. This negative rake angle α in combination with the limited radial distance c produces a limited cut by each tooth and this is even true when the speed of the saw blade is low. Therefore the risk of damaging a tooth or loosing it completely has been reduced. This is of course also due to the narrow opening 6. And in front of each tooth there is a long distance, at least 55%, and preferably at least 70%, of the peripheral distance from the narrow opening to the start of the next tooth, where the maximum radius is maintained. All this also makes the working tool easier and safer to control for the operator. This is of course of major importance.

Each tooth 4 is permanently attached e.g. by welding or soldering or gluing to the blade body 2. The tooth is oriented with its longer side pointing roughly towards the center 11 of the saw blade. It is soldered or welded along one of its longer sides only. It is preferably not fastened at the side being part of the narrow opening 6 but only at the opposite longer side. This is a preferred embodiment. However, it could also be possible to arrange the tooth so that it completely fills the opening in the blade body, i.e. there is no narrow opening 6, and be soldered or welded along one or both of its longer sides. Each tooth has a generally rectangular or rhombic cross-section as seen from the rotational axis of the blade. The blade body is usually made of metal and the blade is usually adapted to be attached to a center shaft or to be supplied with a center shaft. Usually the saw blade has a circular outer periphery 3. This contributes in making the handheld working tool easy to work with.

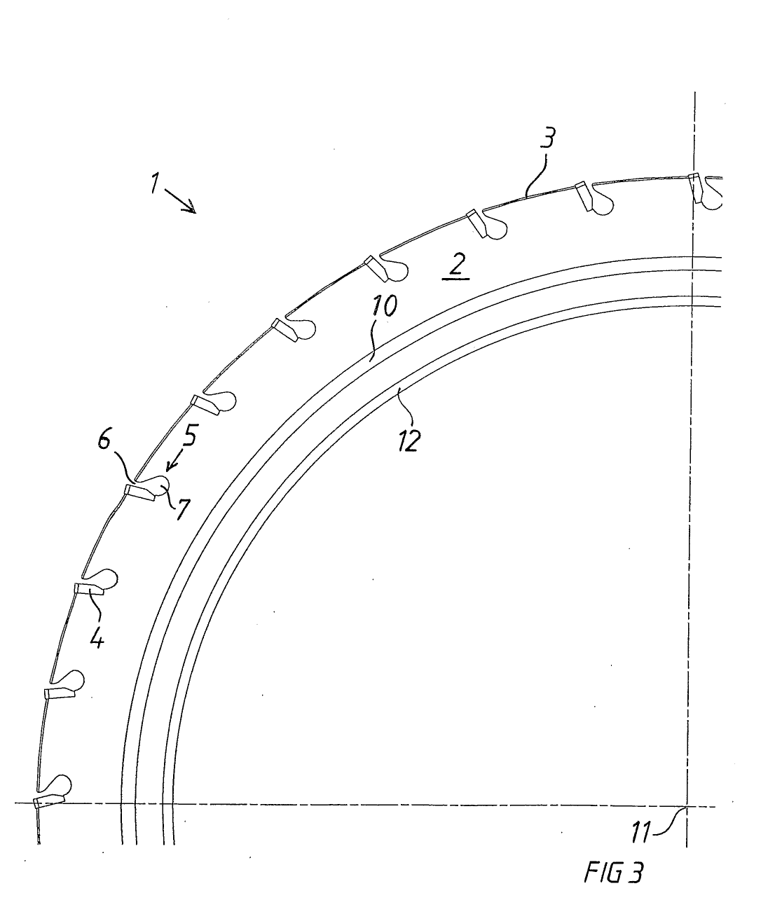

FIG. 3 shows a second embodiment of the invention. Here the blade body 2 is arranged as an annular part supplied with at least one concentric groove 10 located between the inner and outer periphery. The inner periphery is arranged as a V-shaped surface for drive of the saw blade. This saw blade can be used in a so called ring-cutter machine. As it has no center shaft very deep cuts can be made with this machine. It enables the operator to cut through a concrete wall from one side. This is of course of vital importance during an earthquake rescue operation.

1. A saw blade (1) intended for a handheld working tool, and the saw blade comprises a blade body (2) having an outer periphery (3) within a number of teeth (4) arranged by permanent fastening of a separate part or through a local addition of a surface lining material, and the teeth occupy less than 0.2 times of the periphery (3) of the saw blade and in that rotation-wise in front of at least a tooth (4) there is a notch (5) that runs towards the center of the saw blade and this notch has a narrow opening (6) at the periphery and preferably widens considerably inside the opening to a widened part (7) and the widened part has a width (b) that is greater than 1.3 times the width (a) of the opening, characterized in that rotation-wise in front of the narrow opening (6) the outer periphery (3) of the blade body (2) has a maximum radius essentially from a center (11) of the saw blade and this maximum radius is maintained during at least 55% in succession, and preferably during at least 70%, of a peripheral distance from the narrow opening to the start of the next tooth and the tooth (4) has an edge (8) at its outer foremost end, i.e. first in the direction of rotation and a front side (9) of the tooth (4) at the edge (8) forms a negative rake angle α from the edge and to the center (11) of the saw blade, and the angle α is greater than 0 degrees and preferably greater than 8 degrees but smaller than 30 degrees.

2. A saw blade (1) according to claim 1, wherein the edge (8) has a radial distance (c) to the outer periphery of the blade body at the opening (6), which distance (c) is 0.6-5 millimeters and preferably is 0.6-2 millimeters.

3. A saw blade (1) according to any of the preceding claims, wherein the negative rake angle α is greater than 10 degrees but smaller than 20 degrees.

4. A saw blade (1) according to claim 1, wherein the narrow opening (6) is bigger than 0.1 millimeter but smaller than 4 mm, but preferably is bigger than 0.5 mm but smaller than 2 mm.

5. A saw blade according to claim 1, wherein each tooth (4) is permanently attached, e.g. by welding or soldering or gluing to the blade body (2).

6. A saw blade (1) according to claim 1, wherein each tooth (4) is made from carbide tip.

7. A saw blade (1) according to claim 1, wherein the angle ∝α is greater than 8 degrees but smaller than 20 degrees.

8. A saw blade (1) according to claim 1, wherein the blade body (2) is adapted to be attached to a center shaft or to be supplied with a center shaft.

9. A saw blade (1) according to claim 1, wherein the blade body (2) is arranged as an annular part supplied with at least one concentric groove (10) between the inner and outer periphery, and that the inner periphery is arranged as a V-shaped surface (12) for drive of the saw blade.

10. A saw blade (1) according to claim 1, wherein the blade body (2) had a circular outer periphery (3), i.e. its maximum radius is maintained during 100% of the distance between the narrow opening and the next tooth.
